(19) United States
(12) Patent Application Publication
(10) Pub. No.: US 2013/0245942 A1
(43) Pub. Date: Sep. 19, 2013

(54) Indoor navigation using stored geographical bearing information

(71) Applicant: Michael J. Ure, Cupertino, CA (US)

(72) Inventor: Michael J. Ure, Cupertino, CA (US)

(21) Appl. No.: 13/092,050

(22) Filed: Apr. 21, 2011

Related U.S. Application Data
(60) Provisional application No. 61/326,539, filed on Apr. 21, 2010.

(51) Int. Cl. G01C 21/20

(52) U.S. Cl. CPC G01C 21/206
USPC 701/533

(57) ABSTRACT

Indoor navigation may be performed by storing information sufficient to describe a graph in which destinations are ordered along edges each having a geographic bearing associated therewith. A selection is received from a user of a desired destination, and transmissions are received from a plurality of storefront transmitters. The stored information is used to determine a geographic bearing for the user to follow to reach the desired destination, and the geographic bearing is displayed to the user.

The present application claims the benefit of U.S. Provisional Application 61/326,539, incorporated herein by reference.

U.S. Patent Application 2007/0001904 describes a system for indoor navigation using Bluetooth or other RF storefront transmitters. The system as described is believed to be susceptible to improvement in various respects, including user interface and network interaction. The described system conspicuously avoids network interaction to avoid delays in response.

Also known are various WiFi “dongles” designed to connect to a device to provide that device with wireless connectivity. Most such WiFi dongles require the presence of a host device to configure and command the WiFi dongle. One exception is the EyeFi™ memory card. The WiFi portion of the memory card operates autonomously without direction from a host device.

As described in greater detail hereinafter, indoor navigation may be performed by storing information sufficient to describe a graph in which destinations are ordered along edges having a geographic bearing associated therewith. A selection is received from a user of a desired destination, and transmissions are received from a plurality of storefront transmitters. The stored information is used to determine a geographic bearing for the user to follow to reach the desired destination, and the geographic bearing is displayed to the user.

The present subject matter may be more fully understood from the following detailed description in conjunction with the appended drawing figures. In the drawing:

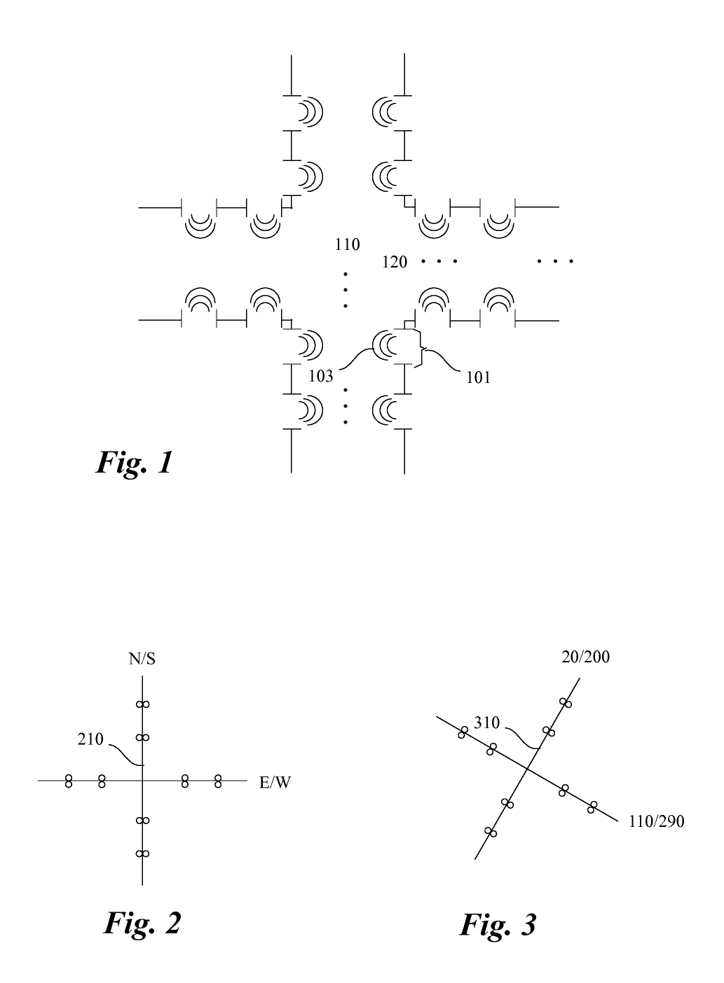

FIG. 1 is a schematic illustration of an intersection of corridors along which storefront transmitters are placed.

FIG. 2 is a first graph representing a situation like that of FIG. 1.

FIG. 3 is a second graph representing a situation like that of FIG. 1.

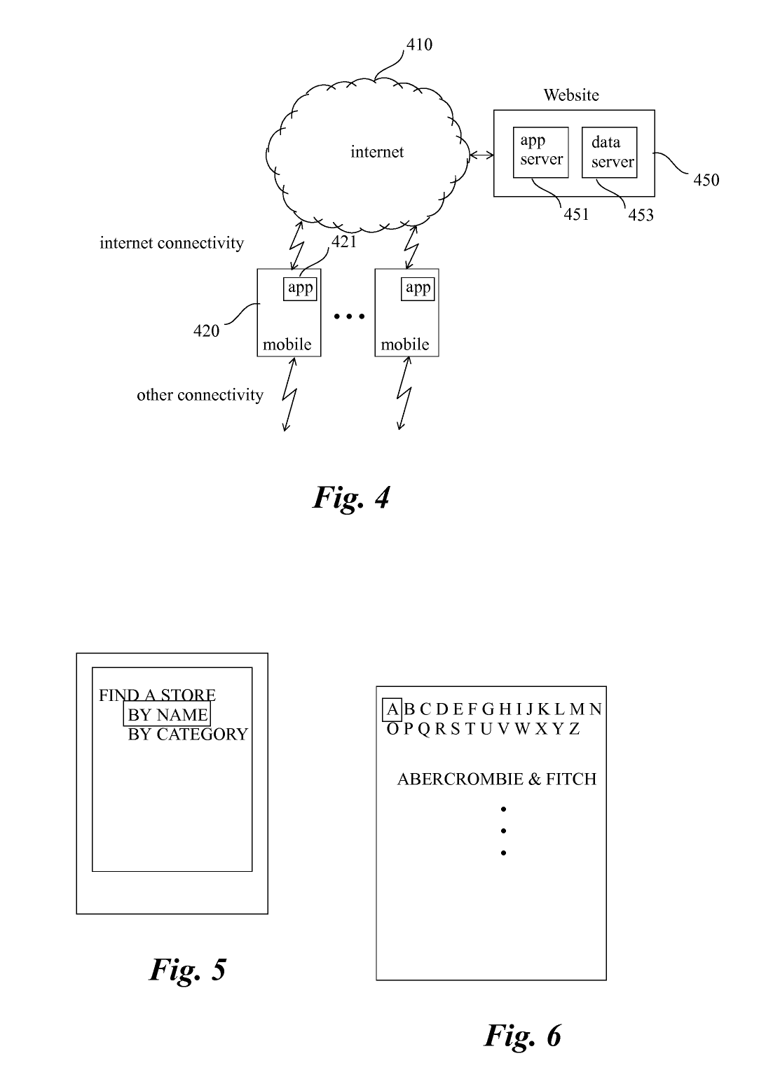

FIG. 4 is a diagram of a system that may be used for indoor navigation.

FIG. 5 is an example of a screen display that may be displayed on the mobile electronic devices of FIG. 4.

FIG. 6 is an example of another screen display that may be displayed on the mobile electronic devices of FIG. 4.

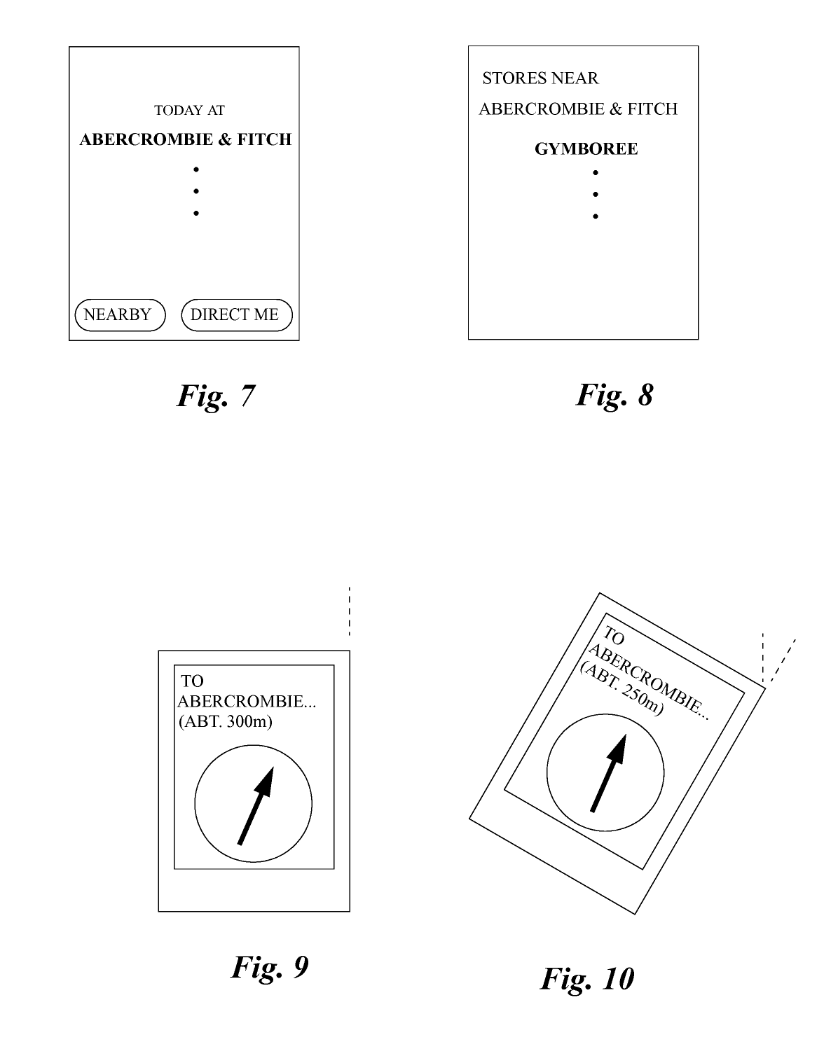

FIG. 7 is an example of another screen display that may be displayed on the mobile electronic devices of FIG. 4.

FIG. 8 is an example of another screen display that may be displayed on the mobile electronic devices of FIG. 4.

FIG. 9 is an example of another screen display that may be displayed on the mobile electronic devices of FIG. 4.

FIG. 10 is an example of another screen display that may be displayed on the mobile electronic devices of FIG. 4.

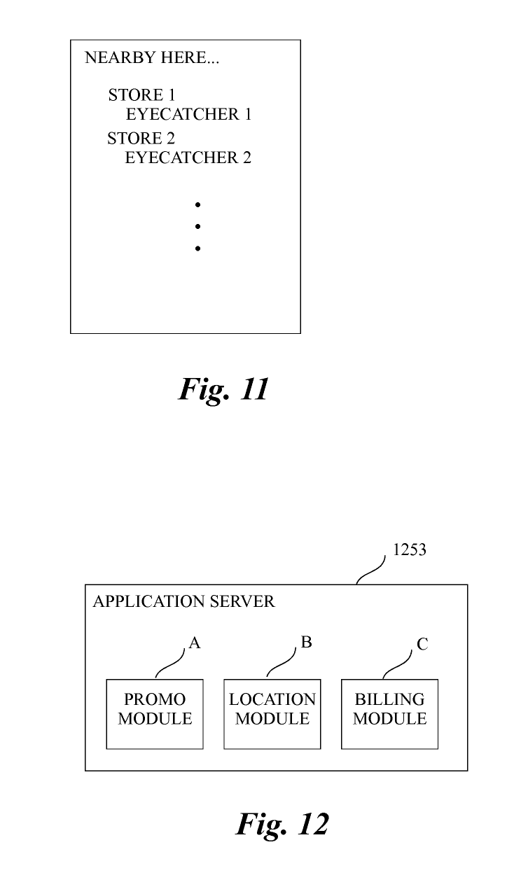

FIG. 11 is an example of another screen display that may be displayed on the mobile electronic devices of FIG. 4.

FIG. 12 is a block diagram of an application server and associated components that may be used in the system of FIG. 4.

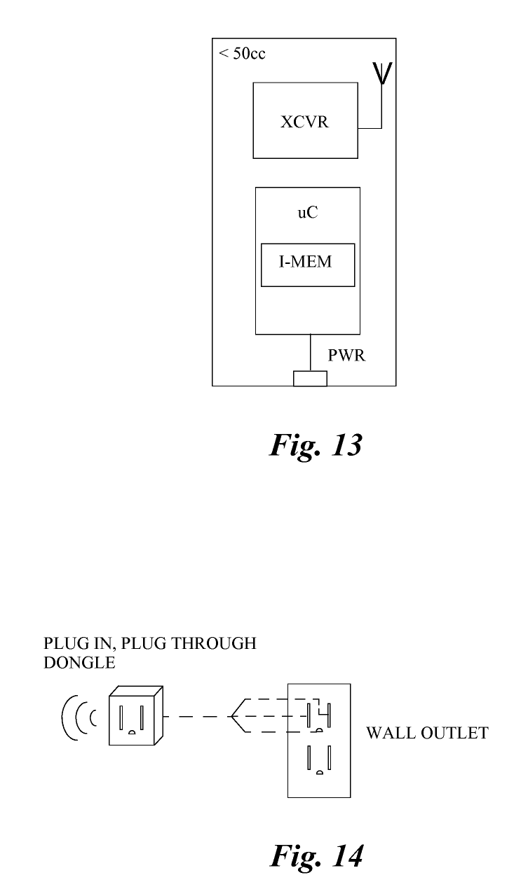

FIG. 13 is a diagram of a dongle that may be used in the system of FIG. 1.

FIG. 14 is a diagram of another dongle that may be used in the system of FIG. 1.

Referring now to FIG. 1, a diagram is shown of one application of the present indoor navigation techniques. Storefronts 101 are located along two intersecting corridors 110, 120. Each storefront has located near it a storefront transmitter. In one embodiment, the storefront transmitters operate continuously during business hours. Radiation patterns 103 from the storefront transmitters are illustrated schematically only. In actual practice, complex radiation patterns result from reflections.

The situation of FIG. 1 may be represented in the form of a graph, examples of which are shown in FIG. 2 and FIG. 3. A corridor such as the corridor 110 in FIG. 1 is represented by an edge (e.g., edge 210) having a geographic bearing associated therewith (e.g., N/S). In the example of FIG. 2, the edge 210 has a geographic bearing of 20/200 degrees. Storefronts are represented as nodes located in order along an edge corresponding to the actual order of the storefronts along the corridor. Any of various different representations for the nodes may be used. Multiple nodes may be allowed to occupy the same location on an edge to allow for facing storefronts, or the locations of the nodes may be offset by some negligible amount. If desired, nodes may have information identifying a node as corresponding to a storefront on one side of the corridor represented by the edge or a storefront on an opposite side of the corridor represented by the edge. Alternatively, a corridor may be represented by two parallel edges each having associated with it nodes representing storefronts on that side of the corridor. If desired, the relative locations of the nodes on an edge may approximate the relative locations of the storefronts represented by the nodes. Note that although a graph is a useful way to think of a collection of data and how it may be organized, the actual data may be stored in any of various different ways.

The data may be stored, for example, accessible to a data server 451 of FIG. 4. The data server 451 may cooperate with an application server 453 to provide a website that is accessible via the internet 410 using, for example, an application 421 running on a mobile electronic device 420 such as an iPhone™, an Android™ phone, a Palm™ phone, a Blackberry™ phone, or other phone, smartphone or mobile electronic device. The application 421 may be configured to cause the mobile electronic device 420 to continually monitor the RF environment looking for transmissions from storefront transmitters. The mobile electronic device 420 is assumed to be provided with a compass application that allows the device to identify and display a geographic bearing.

FIG. 1 may represent a portion of a single level of a multi-story building. In this instance, the building may be represented using a three-dimensional graph having multiple subgraphs, one for each level, with vertical connecting edges between the subgraphs representing elevators, escalators, stairways, etc. Typically, there will be no difficulty determining based on radio transmissions what level a user is currently on.

The storefront transmitters may be any of various types including, for example, WiFi™ (or 802.11) dongles. Such dongles are available from various vendors, such as an 802.11n dongle with USB interface having approximate dimensions of 1.25″×0.5″×0.25″ available from Buffalo Technology, having a U.S. office in Austin, Tex. The dongle contains a control processor, allowing the processor to be configured such that as soon as power is applied the dongle operates in a “stand-alone” mode where it sends out beacons at regular intervals. The dongle may in addition send a pre-programmed message, or even cycle thru a list of pre-programmed messages. Alternatively, a dongle may be configured so as to be reprogrammable and may be provided with a software development tool to enable a program to be developed and programmed into the dongle through a USB port or other port, for example. A custom 802.11 dongle, if needed, may be based on a microcontroller of a type having built-in RF connectivity, available from Microchip of Chandler, Ariz. A diagram of one such exemplary dongle is shown in FIG. 13. Alternatively, a microcontroller-based “dongle adapter” may be used, programmed to control the dongle in the desired manner. Of course, other types of RF dongles besides 802.11 may be used, for example Bluetooth™ dongles, Zigbee™ dongles, RF ID tags, etc.

A dongle may be powered by a charger such as a standard cellphone charger. An adapter may be provided as needed to connect the charger to the dongle.

Alternatively, the dongle may be integrated with a plug-in charger as a compact unit as shown in FIG. 14. If desired, a mechanism may be provided for making plug in of the unit semi-permanent. Further if desired, a plug may be provided on the unit to allow a further device to be plugged into power through the unit. The unit may be configured so as to, in response to power being applied thereto, transmit an identifier periodically or continuously over an extended period of time, for example eight hours, 24 hours, etc.

In another embodiment, the dongle may take the form of a compact WiFi access point, or AP. The AP is preferably wall powered, although it may be powered by a network, such as power over Ethernet (POE), powered photovoltaically, etc. One suitable AP is the Ministation™ AP sold by Ubiquiti Networks of San Jose, Calif. Such an AP is included within the meaning of “dongle” as that term is used herein.

The dongles need not have any network connectivity other than through the “passerby network,” i.e., through mobile electronic devices having network connectivity and running a suitable application. In some instances, the dongles may be software upgradable “over the air” through the passerby network.

A dongle may be fixed inside a storefront window, for example near a bottom edge of the window in a location convenient to wall power. The dongle may be fixed by adhesive or other means. For aesthetic reasons, it may be desirable for the finish of the dongle and the power cord powering the dongle to be chosen so as to be a little noticeable as possible. Installation of the dongle need take only a few minutes and need not require appreciable cooperation of the store tenant.

In other embodiments, the dongles may be fixed outside store windows, elevated above the reach of pedestrian traffic. The dongles may be powered by small solar panels, by “witricity,” or by other means.

During installation, the installer notes a unique ID that will be transmitted by the dongle, together with information identifying the store window where the dongle is installed, for example store name, postal address, etc. This information is entered into a database for use by the application.

In operation of the application, the user is prompted to select a destination, such as finding a store by name or by category as shown in FIG. 5. Assume for example that the user chooses “Find by Name” and then selects the letter “A.” Names of stores that begin with the letter “A” are then displayed as shown in FIG. 6. Assume further that the user selects “Abercrombie & Fitch.” A display like that of FIG. 7 may then be displayed showing promotional information for that store. The promotional information may be provided from a central server or may be provided from the store's own server. Together with the promotional information, the user may be provided the option to select, for example, “Direct Me” to be directed to the selected store, or to select, for example, “Nearby” to learn about stores located near the selected store. In the latter instance, a display like that of FIG. 8 may be displayed, listing stores or destinations located nearby the previously selected store or destination.

Another button, “Nearby Here,” (not shown) may be displayed so as to be accessible at any time, allowing the user to view stores near the user's present location and promotional information for such stores. “Nearby Here” information may be displayed by default, as shown for example in FIG. 11, when directions are not being displayed.

The foregoing promotional information may be primarily textual for purposes of simplicity, or may be media-rich to provide a more engaging user experience.

As opposed to a known “click through” revenue model, a “walk through” revenue model may be used. In this model, promotional information is displayed on a mobile electronic device; access of a user of the mobile electronic device to the promotional information is reported; presence of the user at a location promoted by the promotional information is detected; and if access and presence occur so as to satisfy a measure of closeness in time, a billing event is generated. As shown in FIG. 12, an application server 1253 may include a promotion module A for displaying promotional material on a mobile electronic device, and recording access of a user of the mobile electronic device to the promotional material; a location module B for detecting presence of the user at a location promoted by the promotional material; and a billing module C for, if said access and said presence occur so as to satisfy a measure of closeness in time, generating a billing event.

Alternatively, or in addition, a “buy through” revenue model may be used. For example, a rewards program may be offered to the user, who documents purchase in any of various ways including, for example, photographing a sales receipt at the time of purchase. Various other alternatives may be devised in order to ascertain purchase. A billing event is generated and the user's rewards account is credited. Alternatively, a combination revenue model may be used in which different increments of revenue are billed for click-through, walk-through and buy-through.

In order to direct a user to a selected destination, the application must be able to direct the user the right way at intersections. Referring again to FIG. 1, at intersections, a mobile electronic device will receive relatively strongly transmissions from nodes belonging to two or more edges. The particular intersection may be identified according to which nodes transmissions are received from. Known map navigation techniques may be used to identify a path from the current intersection to the desired destination. The immediate geographic bearing from the current intersection along the identified path to the desired destination is provided to the mobile electronic device which, using a compass application, displays the geographic bearing as shown, for example, in FIG. 9. If distances between nodes are stored in the database, then an approximate distance to the desired destination may also be displayed and updated periodically. Alternatively, distance may be displayed in terms of the number of intervening transmitters (stores, offices, etc.) from which the user may gauge approximate distance. As the orientation of the mobile electronic device changes, the display is changed also to maintain correct display of the geographic bearing toward the desired destination as shown in FIG. 10. During progress toward the destination, the user may be alerted audibly or tactilely when the geographic bearing is changed or is about to be changed.

Arrival at the desired destination may be detected according to radio conditions, including what transmissions are received and with what strengths. For example, the transmission from the desired destination may be expected to be at its strongest, and transmissions will typically be received from adjoining storefronts on either side of the desired destination with strengths indicative of being at or near the desired destination. Radio conditions may also be used to detect when a store has been visited. Such information may be useful in generating service revenue.

The present system allows for the use of “micro-offers.” A micro-offer is an offer made to a person in proximity to a store that has expressed an intention to visit the store, i.e., by requesting directions. Because the making of such offers, and hence the possible acceptance of such offers, may be tightly controlled, different kinds of offers may be made that when using more conventional media channels.

Depending on design considerations, most of the foregoing activity may be performed at the application server or, alternatively, most of the foregoing activity may be performed at the mobile electronic device after downloading the required information to the mobile electronic device. Alternatively, different portions may be performed at both the application server and the mobile electronic device.

With the exception of navigation, all of the foregoing functions may also be provided off-site, away from the mall or venue. In this instance, the “Direct Me” link may be dimmed and inactive, for example. Hence the user may, in preparation for a trip to the mall or venue, explore various possible destinations. Any of various degrees of integration or interaction with the web site of a property manager or the like may be provided.

The storefront RF dongles do not require any network connection. Nevertheless, the equivalent effect of them being network-connected may be obtained by virtue of communication with mobile electronic devices. For purposes of diagnostics, for example, the applications on the mobile electronic devices may gather and report information concerning what transmissions are received by the mobile electronic devices and further particulars such as signal strength, etc. This information may then be uploaded, stored in a database and analyzed to determine various conditions, such as “dongle down,” etc. Such activity may occur in the background, either continuously or at intervals, and may occur for the duration that the mobile electronic device is within range of transmission by a storefront dongle. Control of the storefront dongles may also be exercised through the mobile electronic device applications. For example, it may be desirable to adjust transmit powers of the various storefront dongles. The effect of a connection between a storefront dongle and the application server may be achieved through actions of the application of a mobile electronic device within range of that storefront dongle. By means of appropriate programming of the storefront dongles, tamper-proofing may be achieved to prevent electronic tampering with the storefront dongles.

Although the dongles are referred to herein as “storefront dongles,” in recognition of one conspicuous application of the same, the same or similar approach may be used in a wide variety of contexts, for example locating a classroom or a professor's office or any office, locating a meeting room, locating a booth or pavilion, etc.

The foregoing navigation techniques are advantageous in various respects. Very little vendor action is required, and very little device customization is required for the dongles. Minimal mapping is required. Diagnostic information may be gathered in the background during the course of normal use. Commands to the dongles, if needed, may also be conveyed in the background during the course of normal use.

### ADDITIONAL ASPECTS OF THE INVENTION

1. A method comprising:

displaying promotional material on a mobile electronic device;

reporting access of a user of the mobile electronic device to the promotional material;

detecting at least one of presence of the user or purchase by the user at a location promoted by the promotional material; and

if said access and said presence or purchase occur so as to satisfy a measure of closeness in time, generating a billing event.
2. A computer readable medium comprising instructions for:

displaying promotional material on a mobile electronic device;

reporting access of a user of the mobile electronic device to the promotional material;

detecting and reporting at least one of presence of the user or purchase by the user at a location promoted by the promotional material; and

if said access and said presence or purchase occur so as to satisfy a measure of closeness in time, generating a billing event.
3. A system comprising:

a promotion module for displaying promotional material on a mobile electronic device, and recording access of a user of the mobile electronic device to the promotional material;

a location module for detecting at least one of presence of the user or purchase by the user at a location promoted by the promotional material; and

a billing module for, if said access and said presence or purchase occur so as to satisfy a measure of closeness in time, generating a billing event.
4. Apparatus comprising:

a processor;

a memory coupled to the processor; and

stored within the memory, information sufficient to describe a graph representing destinations at an indoor space, wherein destinations are ordered along edges each having a geographic bearing associated therewith.
5. Apparatus comprising:

a housing having a volume of about 50 cubic centimeters or less;

a microcontroller housed within the housing;

a radio transceiver coupled to the microcontroller housed within the housing;

a power connector whereby power is coupled to the microcontroller and the radio transceiver;

wherein the microcontroller is configured to, of its own accord, cause the radio transceiver to transmit an identifying signal upon power up.
6. The apparatus of aspect 5, further comprising an instruction memory coupled to the microcontroller, wherein the microcontroller is configured to provide for over-the-air programming in which instructions are stored in the instruction memory.
7. The apparatus of aspect 5, wherein the microcontroller is configured to, through the radio transceiver, communicate with mobile electronic devices running an application that is aware of the radio transceiver.
8. A miniature radio transmitter configured so as to, in response to power being applied thereto, transmit an identifier periodically or continuously over an extended period of time.
9. A method comprising:

receiving a request for directions to a destination;

receiving location-indicative information from a mobile electronic device;

displaying direction information on the mobile electronic device; and

presenting an offer on the mobile electronic device for acceptance at the destination.
10. A computer readable medium comprising instructions for:

receiving a request for directions to a destination;

receiving location-indicative information from a mobile electronic device;

displaying direction information on the mobile electronic device; and

presenting an offer on the mobile electronic device for acceptance at the destination.

It will be apparent to those of ordinary skill in the art that the present invention may be embodied in other specific forms without departing from the spirit or essential character thereof. The described embodiments are therefore intended to be in all respects illustrative and not restrictive.

The scope of the invention is indicated by the following claims, not the foregoing description, and all changes which come within the meaning and range of equivalents thereof are intended to be embraced therein.

What is claimed is:

1. A method of indoor navigation comprising:
storing information sufficient to describe a graph in which destinations are ordered along edges each having a geographic bearing associated therewith;
receiving a user selection of a desired destination;
receiving transmissions from a plurality of transmitters;
determining a geographic bearing for the user to follow to reach the desired destination, and
displaying the geographic bearing to the user.

2. The method of claim 1, wherein the transmitters are storefront transmitters.

3. Apparatus comprising:
a processor;
a memory coupled to the processor; and
stored within the memory, information sufficient to describe a graph representing destinations at an indoor space, wherein destinations are ordered along edges each having a geographic bearing associated therewith.

4. The apparatus of claim 3 configured as an indoor navigation system, further comprising:
an interface for receiving a user selection of a desired destination, comprising a display for displaying a geographic bearing to the user; and
a receiver for receiving transmissions from a plurality of transmitters;
wherein said information comprises a database storing information sufficient to describe a graph in which destinations are ordered along edges each having a geographic bearing associated therewith; and
wherein the processor is coupled to the database, the interface and the receiver for determining a geographic bearing for the user to follow to reach the desired destination and for causing the geographic bearing to be displayed on the display.

5. The apparatus of claim 4, wherein the transmitters are storefront transmitters.

6. The apparatus of claim 4, wherein the transmitters are coupled to wall power.

7. The apparatus of claim 4, wherein the transmitters each comprises a USB connector.

8. The apparatus of claim 7, wherein data connections of the USB connectors of the transmitters are not connected to any data source.

9. The apparatus of claim 4, wherein the transmitters are 802.11 dongles.

10. A computer readable medium comprising instructions for:
receiving a user selection of a desired destination;
receiving transmissions from a plurality of transmitters; and
displaying a geographic bearing for the user to follow to reach the desired destination.

11. The computer readable medium of claim 10 comprising instructions for:
communicating to a remote system the user selection;
communicating to the remote system information derived from the plurality of transmitters; and
receiving from the remote system an indication of the geographic bearing.

12. The computer readable medium of claim 10 comprising instructions for:
monitoring transmissions from a plurality of transmitters; and
communicating information derived from said monitoring to a remote system.

13. The computer readable medium of claim 10 comprising instructions for:
communicating to a remote system proximity to a transmitter;
receiving from the remote system a control action to be taken with respect to the transmitter; and
communicating the control action to the transmitter.

14. A computer readable medium comprising instructions for:
storing information sufficient to describe a graph in which destinations are ordered along edges each having a geographic bearing associated therewith;
receiving a user selection of a desired destination;
receiving information derived from a plurality of transmitters;
determining a geographic bearing for the user to follow to reach the desired destination, and
causing the geographic bearing to be displayed to the user.

15. The computer readable medium of claim 14 comprising instructions for performing diagnostics using said information.

16. The computer readable medium of claim 14 comprising instructions for:
receiving an indication of proximity of a mobile electronic device to a transmitter; and
communicating to the mobile electronic device a control action for the transmitter.
